(19) United States
(12) Patent Application Publication
(10) Pub. No.: US 2008/0297585 A1
(43) Pub. Date: Dec. 4, 2008

(54) INTEGRATED CORDLESS VOICE/VIDEO IP PHONE SYSTEM

(75) Inventors: Simon CHUNG, Richmond (CA); Raymond CHOW, Vancouver (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: ASCALADE COMMUNICATIONS INC., Richmond, BC (CA)

(21) Appl. No.: 11/754,654

(22) Filed: May 29, 2007

(51) Int. Cl. H04N 7/14

(52) U.S. Cl. 348/14.02; 348/E07.001

(57) ABSTRACT

Discloses a system for Internet based audio video communications where a user participation in a communications session including a video component includes functionality to enable the participant to provide a video feed that is based on a user selection of a real time video capture or a still capture image. The system provides a toggle control to enable a participant to select between a video capture mode and a still image mode before or during the communications session.

### FIELD OF THE INVENTION

This invention relates to apparatus and method to communicate over the Internet and more particularly relates to a user appliance and computer systems to facilitate delivery of voice and image related content to an Internet telephone appliance having a display.

### BACKGROUND OF THE INVENTION

The Internet provides a popular mechanism for communications between users located anywhere in the world operating an appliance to access the Internet such as a Voice over Internet Protocol (VoIP) device including a personal computer. Communication over the Internet is supported by a wide variety of protocols and content payloads that facilitate delivery of communications data between users anywhere on the Internet. The Internet supports multiple protocols for transport of data payloads between the users to establish and maintain communications between them. For example, a common protocol used is the session initiation protocol (SIP) which is in common use to establish a communications session between users. A user operated SIP client application, or user agent, traditionally uses other protocols, such as TCP and UDP datagrams, to connect to SIP servers and other SIP endpoints, such as telephone style handsets or user agent software applications running on a computer. SIP is primarily used in setting up and tearing down voice or video calls. However, it can be used in other applications where session initiation is a requirement, such as notification messages and the like. Voice/video communications are streaming media communications data streams that are carried out over separate transport protocols, typically the Real-time Transport Protocol (or RTP), which is an Internet Engineering Task Force (IETF) defined standardized packet format for delivering media data streams for example audio and video data streams over the Internet. A user operates a user agent client application on their Internet access device, such as a PC, to participate in various messaging, communications and chat services. Other communications and messaging protocols are in use for communications over the Internet and the features available using such protocols are continually expanding.

Current VoIP implementations suffer from a number of problems and drawbacks, such as poor integration on computers between voice and video-only devices for Internet video calling. Generally, multiple devices are required to fulfill a complete voice/video/cordless user experience for computer-based voice/video calling. For example, existing videophones that are on the market typically require both sides of the call to use compatible and generally proprietary hardware to be able to communicate with each other. Moreover, existing handset devices are also usually corded, which limits the user's freedom.

### SUMMARY OF THE INVENTION

The present invention seeks to overcome at least some of the problems and drawbacks or extant devices by introducing integration between voice and video devices for Internet calling, providing a single device which supports cordless audio and video communications using a computer processor, for example, a personal computer, to interface with the Internet for communications thereover. The device interacts with computer based voice and video calling application software operating on the computer processor, facilitating interoperation compatible with a variety of client server applications and devices on the other side of the call. As a consequence, the need for exact matching of the vendor hardware on both sides of the call is no longer required.

In one of its aspects, the invention provides a VoIP cordless phone handset that communicates over a radio link with a base having an integrated video camera. In a preferred embodiment, the base couples to a USB port on an Internet interface device, such as a personal computer. The user operates the handset to establish a VoIP call. The handset has a video toggle control, for example a button, on it to activate/deactivate the video camera during a call. When the camera is deactivated, a “video muting” mode is established which transmits a video still image which keeps the video connection active for some instant messenger systems rather than having the call dropped when the video is muted.

In accordance with the invention, a cordless phone system has a handset configured for wireless communication with a base station that interoperates with an internet interface appliance computer processor to effect Voice over Internet Protocol (VoIP) communications over a network such as the Internet. The base station has an integrated video camera that captures local video images for input to the computer processor. The phone system enables voice and video calling via suitable application software running on the computer processor of the Internet interface appliance. Preferably the Internet interface appliance is a personal computer thereby allowing users to download and install VoIP and instant messaging applications of their choice. Other specialized computer processors that are dedicated to particular VoIP and/or instant messaging services and ready to operate when powered up can be used as well. The arrangement of the invention allows user operation of the handset and base station equipment to permit functioning both as a cordless phone for voice over IP via the computer processor and as a videophone for video over IP via the computer processor. The voice and video functionality is integrated into the phone system of the present invention using a dedicated “toggle” control on the cordless handset, for example a button, which allows a call to be switched between video and voice-only modes on-the-fly. When in voice-only mode, the system functions like a cordless phone with a cordless handset that the user can take around the house. When in video mode, the user can sit down in front of the base unit and the integrated video camera will capture video of the user which will be supplied to the application software for delivery over the network to the other party in the call. The user will use the handset to speak to the other party, and will be able to see the other party via a display region on the computer monitor. A one-touch “toggle” function on the cordless handset allows the user to switch between these two calling methods on-the-fly during a call.

### BRIEF DESCRIPTION OF THE DRAWINGS

Embodiments of the present invention will now be described, by way of example only, with reference to the attached Figures, wherein:

FIG. 1 is a functional block diagram of an embodiment of the invention.

FIG. 2 is a functional block diagram of components of a first embodiment of an internet interface device of the present invention;

FIG. 3 is a functional block diagram illustrating components in a USB base station of the present invention;

FIG. 4 is a functional block diagram illustrating an architecture of a second embodiment of an internet interface device of the present invention;

FIG. 5 is a functional block diagram illustrating an architecture of a handset of the present invention;

FIG. 6 shows an elevation view of an embodiment of a wireless handset and base constructed in accordance with the principles of the invention;

FIG. 7 is a functional block diagram of hardware elements included in an embodiment of the base station of FIG. 1; and

FIG. 8 shows a functional block diagram of components in an embodiment of a handset constructed in accordance with the principles of the present invention.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored on a machine-readable medium (also referred to as a computer-readable medium, a processor-readable medium, or a computer usable medium having a computer readable program code embodied therein). The machine-readable medium may be any type of magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

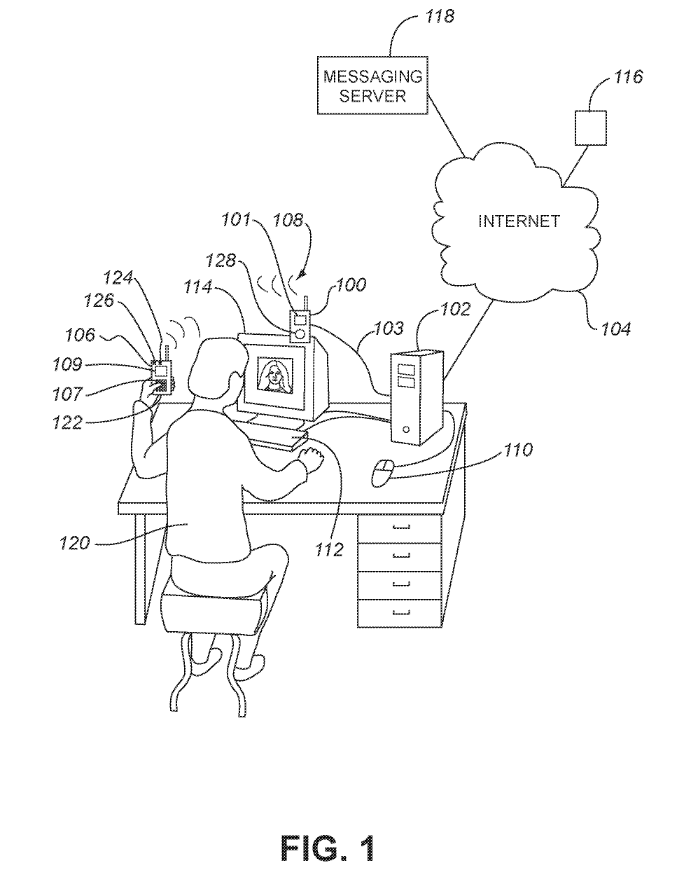

FIG. 1 is an illustration of an embodiment of the invention. A base station 100 connects to an Internet Interface Appliance 102 having a computer processor adapted for running user agent client applications to effect voice over protocol (VoIP) or instant messenger communications over a network such as the Internet 104. In a preferred embodiment, the Internet Interface Appliance 102 is a personal computer configured to run a plurality of applications using a suitable operating system such as the Microsoft Windows (Trade-mark) operating system. A telephone handset 106 is in wireless communications with the base station 100 over a wireless channel 108. The wireless handset communicates with base station 104 over a wireless communications channel 106 using standard wireless connections such as in the 900 MHz, 1.8, 2.4 or 5.8 GHz bands using a suitable digital encoding protocol, for example, the Worldwide Digital Cordless Telecommunications (WDCT) or Digital Enhanced Cordless Telephone (DECT) standards for wireless telephone handset communications. A recharge station 101 is provided in the base where the wireless handset can be placed when not in use to recharge the batteries of the wireless handset. The communications between the handset and base station over the wireless channel is bidirectional and includes both audio signaling as well as control and supervisory signaling to facilitate exchange of call control information and supervisory signaling between the handset and base station as well as audio communications delivered to and received from the user of the wireless handset 106.

Communication between the base 100 and the internet interface device 102 is effected by a wireline coupling 103 which is preferably over a standard coupling interface such as a universal serial bus (USB) connection or an IEEE 1394 connection which facilitates exchange of call control and supervision signaling between the handset and the base station and the internet interface device 102. In a preferred embodiment, the wireline coupling provides power to the base station 100 so a separate power supply or battery for the base station is not required. The Internet interface device 102 provides a computing platform to operate a VoIP client to facilitate and effect VoIP communication over the Internet 104. The Internet interface device VoIP client can take one of several forms depending on the nature of the VoIP service provider 116 providing the VoIP service to the user of handset 106. Common VoIP services that are available, which provide client software to operate on personal computers, include Skype (trade-mark), Windows Live Messenger (trade-mark) and numerous others.

Wireless handset 100 provides a keypad 107 which includes a supervisory function keys as for example power on and off buttons, menu and select buttons as well as the dial number input buttons 0 through 9, octothorp and asterisk common to dual tone multifrequency (DTMF) touch-tone telephones. In this manner a conventional telephone handset device is presented to a user to initiate and receive VoIP calls over the Internet. The wireless handset may include a graphical display 109 to provide the user with an output that can be configured and changed over time by the applications running on the wireless handset 100 under software control. For example, the display 109 may display a buddy list of Skype (trademark) users and their current status in a manner corresponding to the buddy list that appears on the output computer monitor display 114 of the personal computer when a user is operating a Skype (trademark) softphone client on the PC. The handset also includes a microphone 122 and earpiece 124 to allow the user to use the wireless handset in a conventional manner familiar to a telephone user.

When the Internet Interface Appliance 102 is implemented as a personal computer, conventional user interface services are available with user input devices such as a mouse 110, a keyboard 112 and user output devices such as a computer monitor 114 to output a graphical display. The user activates a communications application on the Internet Interface Appliance 102 to make a call to a remote user 116 or to receive a call from a remote user 116 where the communications between the two users take place over the Internet 104. Each user relies on a communications service provider that operates a communications server 118. The communications server interoperates with the user devices, such as 102, 106 and 116, to establish, supervise and disconnect calls taken place between users of the messaging system. The messaging system includes VoIP calls such as are operated by a number of VoIP service providers or instant messaging services that allow real time video and voice communications between users such as Skype (Trade-mark) or Windows Live Messenger (Trade-mark) or other such messaging applications. The user 120 uses a telephone handset 106 to exchange audio communications with the remote user 116. The handset 106 has a microphone 122 to pick up local audio and an earpiece 124 to output audio locally to allow the user to effect voice communications with the remote user 116. The handset has a dedicated video toggle control 126 embodied as a toggle button which is used to activate and de-activate video camera 128. The video camera can be used to capture still images or a video sequence to a video library. Alternately, the user can populate the video library with any desired still image or video sequence. The user is then able to configure the system to select a still image or a stored video sequence to be provided to the communication session when the local video camera 128 is de-activated. In this manner, the user is permitted the capability to use the video toggle control to select between transmitting a local video capture during the communication session or to provide a still image or stored video sequence. The user selection or toggle between a local video capture and a configured selection from the video library can be made at the initiation or receipt of a call or at any time during the call communication session itself.

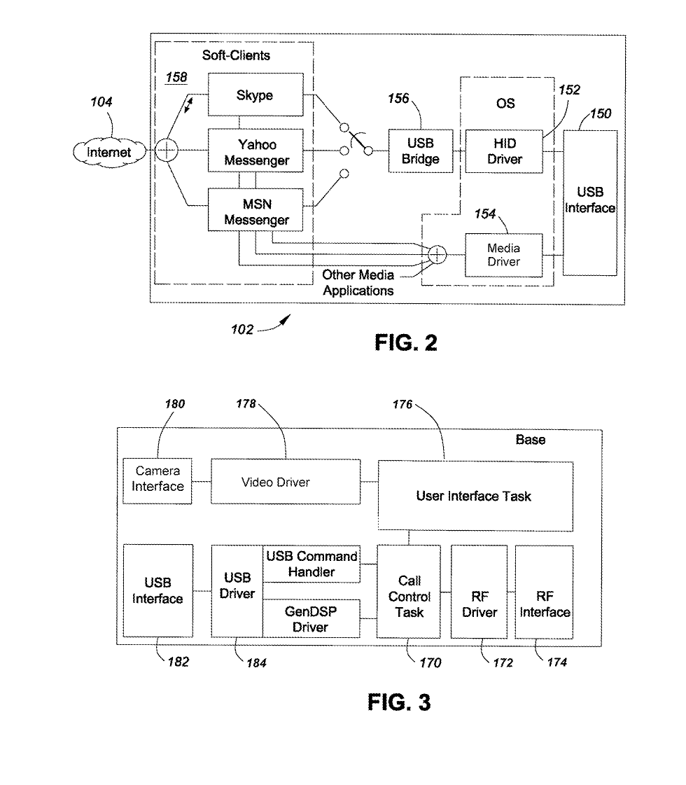

FIG. 2 shows a functional block diagram of components of a first embodiment of an Internet interface appliance device 102, which is embodied as a personal computer (PC). The PC includes a USB interface 150, which is used to supply power to and communicate over USB wire line coupling 103 of FIG. 1. The PC runs an operating system (OS) program, such as a version of Linux (trademark) or of the Windows (trade-mark) operating system provided by Microsoft (trademark), for example, Windows Vista (trademark) or Windows XP (trademark). The operating system provides a framework to establish and operate software providing driver functionality to interact with the USB interface 150 including a human interface device driver (HID) 152 as well as a bidirectional media driver 154. The media driver 154 accommodates audio data streams and image data streams including either still image or moving image or video data streams. The media driver provides the capability to support data transfer in either direction to represent the audio portion and or the video portion of the streaming data. The USB bridge application 156 controls communication with the USB interface 150 and interacts with one or more VoIP soft clients 158, where Skype (trademark), Yahoo Messenger (trademark) and Windows Live Messenger (trademark) are shown by way of example in the figure. The softphone clients 158 control and facilitate communication over the internet 104 with a VoIP service provider messaging server 118 to initiate and receive messages or calls to and from other remote users 116 of the VoIP service corresponding to the selected softphone client operating on the PC internet interface device.

FIG. 3 shows a functional block diagram of components in a USB base station of the present invention arranged to interoperate with a PC configured as described with reference to FIG. 2. The base station includes a software application operable on a computer processor provided in base station 100 to control and support the functionality of the base station in effecting communications between the Internet interface device 102 and the wireless handset 100. The base station runs a call control task 170 that controls and coordinates the operation of the base station elements. A radio frequency (RF) driver 172 and RF interface 174 supports the particular protocol driver mechanism and RF interface to effect radio communication over the wireless channel 108 between the base and the handset. Those skilled in the art will appreciate that numerous wireless protocols can be implemented by providing suitable functionality in a various RF implementations such as the DECT standard, an analogue or a digital spread spectrum (DSS) application operable on a suitable radio channel, for example, 900 MHz, 1.8, 2.4 or 5.8 GHz radio communications channel. A user interface task 176 communicates with the call control task 170 to provide user functionality at the base 100. For example, the base includes a video camera 128 and the user causes the video camera 128 to capture local video by manipulating a video toggle control 126, provided in the preferred embodiment as a button on the handset 106. User manipulation of the video toggle control button switch is monitored by the User interface task 176, which commences or ceases output capture from the video driver 178 which communicates with a video camera interface 180 coupled to the video camera 128.

A wireline interface 182 is provided to connect to the wireline coupling 103 connecting the base to the Internet interface device. In the preferred embodiment, the wireline interface 182 is a universal serial bus (USB) interface as that permits the base to receive power from the internet interface device 102 as well as effect bidirectional communications between the internet interface device and the base of both the audio signaling that allows user communication using the VoIP protocol over the internet as well as facilitate handling of call control signaling such as off hook, on hook and ring tone, dial tone functionality or exchange of buddy list updates with the soft phone client application running on the internet interface device. The wireline interface 182 is controlled by handler and driver applications 184 which are tailored to and written for the specific media of the wireline coupling that extends between the base and the Internet interface device. In the specific embodiment shown in FIG. 3, USB drivers and command handlers are provided to control the behavior of the USB type wireline interface 182.

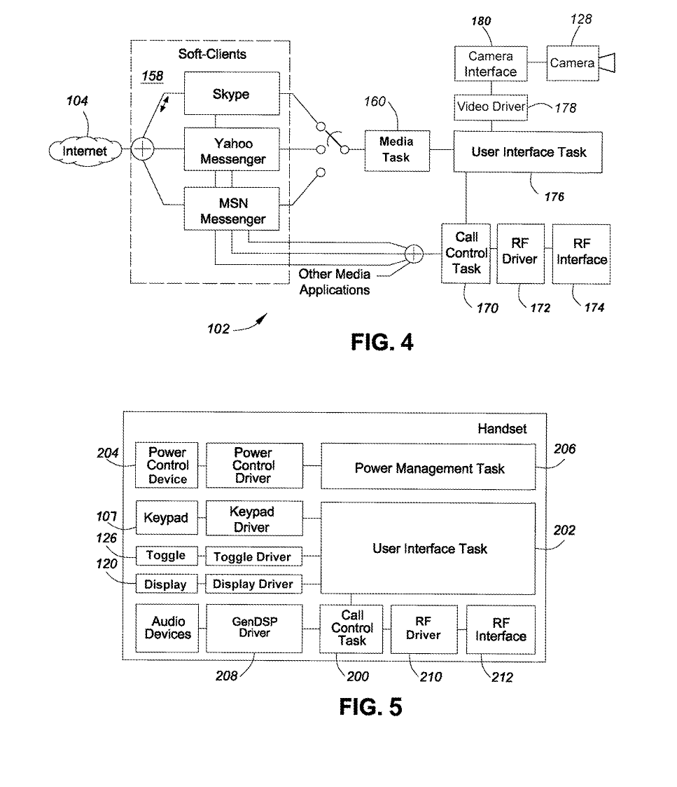

FIG. 4 shows a functional block diagram of components of a second embodiment of a base station Internet interface device of the present invention. In this embodiment, the base includes the necessary hardware and software and does not require a separate personal computer (PC) for operation of the system of the invention. Consequently, the need for a PC and a USB wireline coupling in accordance with the embodiment of FIGS. 2 and 3 of the invention is obviated. The base Internet interface appliance 102 runs an operating system (OS) program, such as a version Linux (trademark) or possibly a version of the Windows (trade-mark) operating system provided by Microsoft (trademark), for example, Windows Vista (trademark) or Windows XP (trademark). The operating system provides a framework to initiate and operate application software including user agent applications 158 to effect media and messaging communications over the Internet 104. The user agent clients include applications such as those for communication using Skype (trademark), Yahoo Messenger (trademark) or Windows Live Messenger. The OS provides a framework for driver functionality to interact with the RF interface 172, 174 as well as operation of a bidirectional media task 160 to enable the user interface task 176 to facilitate user selection of the particular user agent application 158 that is to be used for communication. The media task 160 accommodates audio data streams and image data streams including either still image or moving image or video data streams. The media task provides the capability to support data transfer in either direction to represent the audio portion and or the video portion of the streaming data communication. The call control task 170 and user interface task 176 co-operate to enable the video camera 128 to be used to capture still images or a video sequence to a video library. Alternately, the user can populate the video library with any desired still image or video sequence. The user is then able to configure the call control task and user interface task of the system to select a still image or a stored video sequence that is to be provided to a communication session when the local video camera 128 is toggled to become de-activated. In this manner, the call control task provides the user with the capability to use the video toggle control to select between transmitting a local video capture from the camera 128 during a communication session or to provide a user configured and selected still image or stored video sequence during the communication session. The user selection or toggle between a local video capture and a configured selection from a video library accessible to the call control task is made at the initiation or receipt of a call or at any time during the call communication session itself.

The softphone clients 158 control and facilitate communication over the internet 104 with a VoIP service provider messaging server 118 to initiate and receive messages or calls to and from other remote users 116 of the messaging or VoIP service corresponding to the selected softphone client operating on the Internet interface device 102. The base station runs a call control task 170 that controls and coordinates the operation of the base station elements in communication with the handset 106. A radio frequency (RF) driver 172 and RF interface 174 supports the particular protocol driver mechanism and RF interface to effect radio communications over the wireless channel 108 between the base and the handset. As with the embodiment depicted in FIGS. 2 and 3, those skilled in the art will appreciate that numerous wireless protocols can be implemented by providing suitable functionality in a various RF implementations such as the DECT standard, an analogue or a digital spread spectrum (DSS) application operable on a suitable radio channel, for example, 900 MHz, 1.8, 2.4 or 5.8 GHz radio communications channel. The user interface task 176 communicates with the call control task 170 to provide user functionality at the base Internet interface device 102. For example, the base includes a video camera 128 and the user causes the video camera 128 to capture local video by manipulating a video toggle control 126, provided in the preferred embodiment as a button on the handset 106. User manipulation of the video toggle control button switch is monitored by the User Interface Task 176, which commences or ceases output capture from the video driver 178 that communicates with a video camera interface 180 coupled to the video camera 128. The call control task 170 allows user communication using a messaging or VoIP protocol over the Internet as well as facilitating handling of call control signaling such as off hook, on hook and ring tone, dial tone functionality or exchange of buddy list updates with the soft phone client application running on the Internet interface device base 102.

FIG. 5 shows a functional block diagram illustrating an architecture of an embodiment of the telephone handset 106 of the present invention including function blocks for the applications running on a computer processor system of the wireless handset 106. The handset has a call control task 200 that coordinates the user manipulation of the handset as well as the communications between the base and handset over the wireless channel 108 as depicted in FIG. 1. The handset includes a user interface task 202 that coordinates the information provided to the user on the handset graphical display 109 by communication between the user interface task and the LCD driver. User manipulation of the handset keypad 107 is communicated to the user interface task 202 by means of an associated keypad driver. In this manner user input to the handset and user output from the handset on the keypad and LCD is coordinated at the handset. A battery powers the handset and a power control device 204 provides the necessary electrical coupling between the base station recharge cradle 101 and the batteries held within the handset itself. To control charging of the batteries and provide an indication of the charge level of the batteries to the user, a power management task 206 is preferably included as a software application on the handset.

Audio communication to the microphone and earpiece of the handset is controlled by a general digital signal-processing driver (GenDSP) 208, which controls and supports the audio signaling over the handset. The RF signaling between the base and handset is supported by a protocol driver application 210 and RF interface device 212. User manipulation of the video toggle control 126 is monitored and communicated by user interface task 202 over RF interface 212.

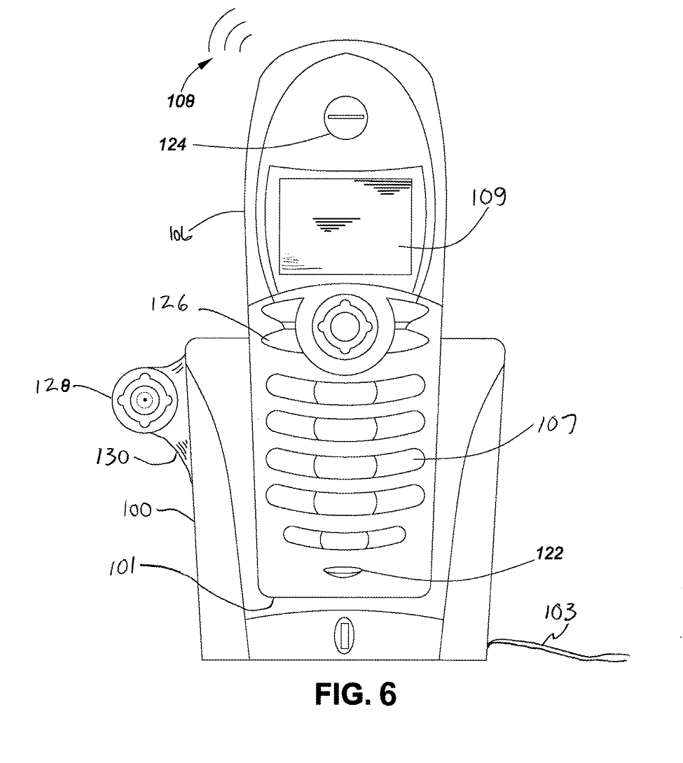

FIG. 6 shows an elevation view of an embodiment of a wireless telephone handset 106 base 100 constructed in accordance with the principles of the invention. The handset includes an antenna to couple to wireless channel 108 allowing audio and control information to be exchanged between the handset and base station 100. The handset has a graphic display 109 output device that provides a general color display device configurable to show graphical elements or text characters. A camera 128 is mounted on the base preferably with an articulated mount 130 that permits the camera to be pointed in a desired direction while the base is at rest on a surface such as on a computer monitor or table top. When the base is configured to interoperate with a PC in the embodiment depicted in FIGS. 2 and 3, a USB wireline coupling 103 extends between the base and the PC enabling the handset and base to receive power from the PC and communicate with the PC. As will be understood, when the base is configured to interoperate with the Internet in accordance with the embodiment of FIG. 4, then wireline coupling 103 will provide powering and possibly Internet connectivity to the base 100 and, consequently, the handset 106. As will be understood, the base 100 may communicate with a WiFi (trademark) wireless router or WiMax (trademark) wireless Internet connection to eliminate the need for wireline coupling 103 to provide Internet connectivity to the base 100.

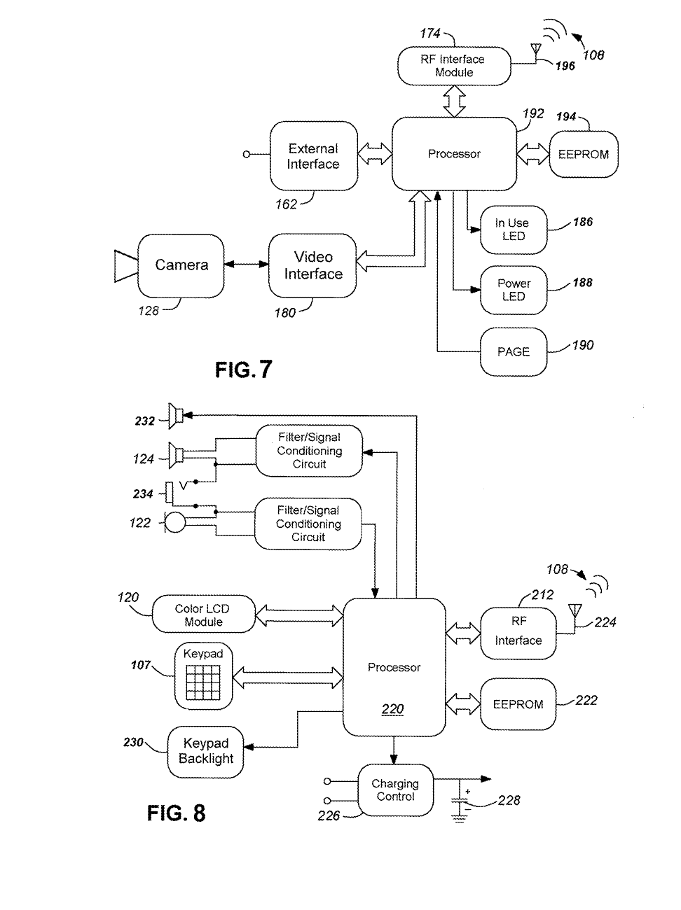

FIG. 7 shows a functional block diagram of hardware elements included in an embodiment of the base station 100 of FIGS. 2 or 4. The base station has a base band processor 192 computing device and memory device 194 to store the software applications that control the base as described more fully with reference to FIGS. 2 or 4. The processor 192 preferably has outputs to activate an in-use LED 186 and a power LED 188 as well as receive input from the page switch 190. The processor communicates with the RF interface module 174 that controls the operation of the RF interface. An antenna 196 couples the RF interface module to the wireless channel 108. An external interface 162 couples the base station unit directly in the embodiment of FIG. 4 or indirectly in the embodiment of FIG. 2 with the Internet 104. In the embodiment of FIG. 2, the external interface 162 is the USB interface 186, which has a USB controller 186 in communication with processor 192 to exchange control and communications signaling between the processor and the USB interface. In the embodiment of FIG. 4, the external interface 162 couples to a device such as a router or modem to effect communications over the Internet.

FIG. 8 shows a functional block diagram of components of an embodiment of a handset constructed in accordance with the principles of the invention. The handset includes a base band processor 220 to provide a computing platform to execute the applications and functions described more fully with reference to FIG. 4. Memory device 222, such as an Electrically Erasable Programmable Read Only Memory (EEPROM), is coupled to processor 220 and is used to store the software that operates the wireless handset. An RF interface module 212 is connected to the processor 220 and a handset antenna 224 to facilitate communication between the handset and the base over wireless channel 108. When the handset is cradled in the recharge station 101 an electrical connection is established from the recharge station to the changing control centre 226 to recharge the handset battery 228 under control of the processor 220. Optionally the handset keypad 107 is provided with a keypad backlight 230 to enable use of the handset keypad in darkened environments. Further, the handset may include a hands-free speaker 232 and a headset connector 234 to allow input and output of audio from the handset through additional elements apart from the ear piece 124 and microphone 122 conventionally provided on the handset.

Now that the invention has been described with reference to then embodiments herein described, numerous modifications and substitutions and equivalents will occur to those skilled in the art. The invention is not, however, limited to the specific embodiments herein described but rather is defined by the claims appended hereto.

What is claimed is:

1. A system for integrated audio video communications over a data network such as the Internet comprising:
i. a telephone handset in wireless communication with a base, the base including an interface to provide call control and audio and video communication signaling for a communications session over the data network;
ii. a local video source to provide video data for the video communication signaling, and
iii. a toggle control operable by a user to supply said video data from a local real time video capture device or a video library.

2. The system of claim 1 wherein said communications session is compatible with at least one of: Skype (trademark), Windows Live Messenger (trademark), Yahoo Messenger (trademark).

3. The system of claim 1 wherein said base includes recharge cradle to receive and provide a recharge current to said telephone handset.

4. The system of claim 1 wherein said base includes a video camera for said local video source and a USB connection to a personal computer, the personal computer configured to provide said call control and audio and video communications signaling to effect a communications session over said data network via said USB connection.

5. The system of claim 5 wherein said personal computer is configured to execute a user agent application selected from at least one of: Skype (trademark), Windows Live Messenger (trademark), Yahoo Messenger (trademark).

6. The system of claim 1 wherein said video library comprises a user configurable stock of still image or stored video sequences.

7. A method for integrated audio video communications over a data network such as the Internet using a handset having a computer processor in wireless communication with a base also having a computer processor, the base including an interface to facilitate call control and an audio and video communications session over the data network comprising the steps of:
i. providing a toggle control on the telephone handset;
ii. supplying a video source to the communications session from a local video source, and
iii. responding to said toggle control to supply said video source to the communications session from a local real time video capture device or a video library.

8. The method of claim 8 wherein said communications session is compatible with at least one of: Skype (trademark), Windows Live Messenger (trademark), Yahoo Messenger (trademark).

9. The method of claim 7 wherein said base includes a video camera for said local video source and a USB connection to a personal computer, the personal computer configured to provide said call control and audio and video communications signaling to effect the communications session over said data network via said USB connection.

10. The method of claim 9 wherein said personal computer is configured to execute a user agent application selected from at least one of: Skype (trademark), Windows LIve Messenger (trademark), Yahoo Messenger (trademark).

11. The method of claim 7 wherein said video library comprises a user configurable stock of still image or stored video sequences.
